(19) United States
(12) Patent Application Publication
(10) Pub. No.: US 2009/0319205 A1
(43) Pub. Date: Dec. 24, 2009

(54) Monitoring System, Especially Vibration Monitoring System, and Method for Operating Said System

(75) Inventors: Thomas Borger, Klein-Zimmern (DE); Walter Kreb, Schwanheim (DE); Ulrich Lehmann, Worth (DE); Robert Schwab, Karisruhe (DE); Hans-Günther Sieberling, Hoffheim (DE); Raimund Trockel, Mühltal (DE)

Correspondence Address: SIEMENS CORPORATION;INTELLECTUAL PROPERTY DEPARTMENT, 170 WOOD AVENUE SOUTH, ISELIN, NJ, 08830, US

(73) Assignee: SIEMENS AKTIENGESELLSCHAFT, Munchen (DE)

(21) Appl. No.: 12/086,662

(22) PCT Filed: Dec. 18, 2006
(86) PCT No.: PCT/EP2006/069825

§ 371 Date: Aug. 17, 2009

(30) Foreign Application Priority Data
Dec. 19, 2005 (DE) 10 2005 060 720.9

(51) Int. Cl. G06F 19/00; G01N 29/00; G06F 15/00

(52) U.S. Cl. 702/56; 702/188

(57) ABSTRACT

There is described a monitoring system, especially a vibration monitoring system, and a method for operating said system. The system is finely adjustable between purely single-channel to one fault tolerant and limited two fault tolerant without the necessity of additional special hardware components.

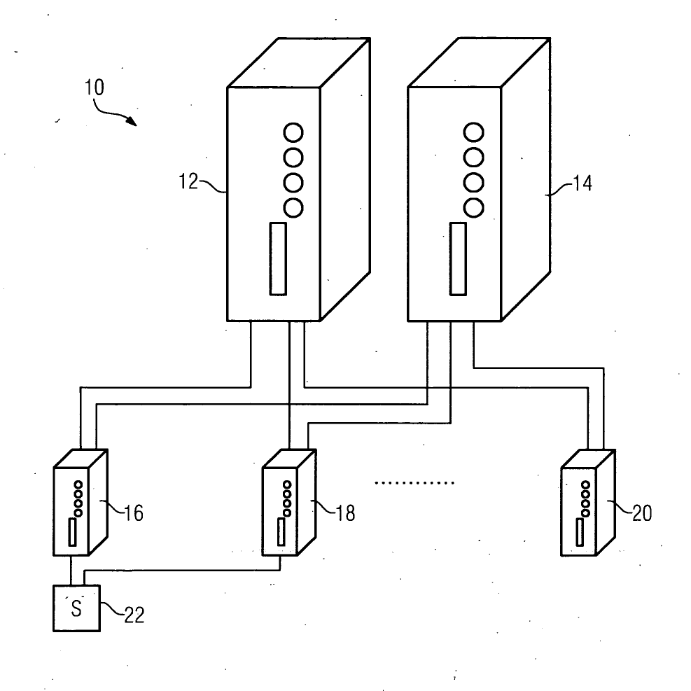

### CROSS REFERENCE TO RELATED APPLICATIONS

This application is the US National Stage of International Application No. PCT/EP2006/069825, filed Dec. 18, 2006 and claims the benefit thereof. The International Application claims the benefits of German application No. 10 2005 060 720.9 DE filed Dec. 19, 2005, both of the applications are incorporated by reference herein in their entirety.

### FIELD OF INVENTION

The invention relates to a monitoring system, especially a vibration monitoring system, as well as to a method for operating said system.

### BACKGROUND OF INVENTION

Monitoring systems are generally known. They comprise at least one sensor as the sensor system, with the sensor or each sensor on the monitored system accepting data which allows information to be provided about the state of the system. To reduce the amount of wiring in complex systems the use of field devices, to which a plurality of sensors as well as other process periphery can be connected, has become widespread. Such field devices are referred to in this document by the generic term of preprocessing unit.

### SUMMARY OF INVENTION

The invention relates especially to a monitoring system of the above type, especially to a vibration monitoring system, meaning a system that detects unusual vibrations of a technical system, such as a gas turbine for example, i.e. vibrations with an unusual amplitude and/or frequency, and does so especially in a fault-tolerant manner, and where necessary also initiates measures in conjunction with such detected situations, especially the switching off of the system as a whole or of relevant subsystems, also conducting such activities in a fault-tolerant manner. To perform this function, in a monitoring system of the type mentioned at the start with a plurality of sensors, including at least one in a redundant configuration, with at least one preprocessing unit and at least one processing unit, there is provision for each sensor to be redundantly connected to at least one preprocessing unit and for each preprocessing unit to be redundantly connected to at least one processing unit. A sensor, where necessary also each sensor, can thus be made accessible in accordance with the invention to one or to two preprocessing units. This is selected individually for each sensor, especially by the appropriate connection, i.e. by using the redundant connection capability. Furthermore each preprocessing unit is also designed so that it can be connected to one or to two processing units, e.g. to a so-called central station of a control system.

The advantage of the invention lies in the fact that, without the use of specific hardware, the degree of availability of the monitoring system can be varied over a wide area. In its full configuration the monitoring system is even one-fault-tolerant, and is so in the sense that a single fault in the monitoring system does not result in any loss of information. This still applies even if a single fault occurs in the preprocessing units and/or the processing units.

The dependent claims are directed to preferred embodiments of the present invention.

Preferably each sensor features contacts for redundant connection to two preprocessing units. This allows individual definition for each sensor of whether the data item supplied by this sensor is intended for redundant processing by a subsequent preprocessing unit.

There is also preferably provision for the monitoring system in an actual version, i.e. above and beyond the pure possibility formulated above, to actually feature at least two preprocessing units, i.e. a preprocessing unit and a redundant preprocessing unit. In this case at least one sensor is simultaneously connected to a preprocessing unit as well as to a redundant preprocessing unit. As well as the at least one preprocessing unit and its respective redundant pendant, the monitoring system can feature further preprocessing units which are not necessarily included in the redundancy.

If each preprocessing unit has interfaces for redundant connection to two processing units, the communication path from each preprocessing unit to the respective processing unit can also be embodied redundantly or non-redundantly in accordance with the respective general conditions from the technical process. The decision in this regard is made by the installation planners or if necessary also the commissioning engineers.

In a further preferred embodiment, unlike in the simple possibility formulated above, an actual embodiment of the monitoring system as regards the processing units actually also includes at least one processing unit and at least one redundant processing unit for said unit. Further processing units can be provided without being included in the redundancy. In such an embodiment of the monitoring system there is further advantageous provision for at least one preprocessing unit to be simultaneously connected to a processing unit and to a redundant processing unit for said unit. There is especially preferably provision, with at least one preprocessing unit and its redundant preprocessing unit, for the preprocessing unit to be simultaneously connected to a processing unit as well as to a redundant processing unit for said unit and likewise for the redundant preprocessing unit to be connected to a processing unit or the processing unit and simultaneously to a redundant processing unit for said unit. This produces a redundancy at the level of the preprocessing unit, at the level of the processing unit and also at the level of the communication link existing between the two levels.

To operate the inventive monitoring system a method included in the invention is provided, in which sensor data is transferred from one or from each sensor to the or to each respective connected preprocessing unit, and terminal data is transferred from the or from each preprocessing unit to the or to each respective connected processing unit. Both the expression “preprocessing unit” and also the expression “processing unit” includes the respective unit itself and any redundant pendant which may be present. These expressions will continue to be used below.

There is preferably further provision, on receipt of redundant sensor data, for each preprocessing unit to carry out voting. Thus if a preprocessing unit receives the corresponding redundant sensor data from redundant sensors which, providing the sensors and the respective transmission link are functioning normally, is basically intended to represent the same or at least essentially the same values, in the case of deviations in a group of such data the forwarding of that data or that item of data which includes the greatest plausibility can be initiated by means of voting. Voting as such is known per se and is not further explained here.

A similar processing step can additionally or alternately also be performed at the level of the processing unit on receipt of redundant terminal data. If after transfer of the sensor data from the sensor or from each sensor to the preprocessing unit and from there after a forwarding of the if necessary transformed, e.g. analog-digital-converted sensor data, to one or more processing units in the form of terminal data, the actual process data is thus finally available at the level of the processing unit, with a monitoring system with one processing unit and a redundant processing unit there can be provision that, in conjunction with the sensor data, i.e. the actual underlying data, an action by the processing unit or the redundant processing unit only occurs if processing unit and redundant processing unit have the same terminal data i.e. the data stemming from the sensor data, or after voting in conjunction with terminal data, have the same data or essentially same data available in this respect. With monitoring of e.g. a gas turbine for unusual vibrations an exception situation is then handled, i.e. handling of unusual frequencies or amplitudes for example, especially by way of switching off the gas turbine or individual units of this gas turbine when and only when the assumed unusual vibration data, depending on available redundancy, i.e. depending on configuration level of the monitoring system, is present at processing unit level in secured form, i.e. if data that points to unusual vibrations is available from at least two redundant sensors, or if no redundant sensors are present, a processing of the sensor data by at least two redundant preprocessing units has taken place, or if no redundant preprocessing units are present, a processing of the terminal data by at least two processing units has taken place. As well as the option of dispensing with redundancy at the individual levels, there is naturally also the option of embodying each level redundantly and improving the reliability of the monitoring system overall in this way. Thus handling of an exception situation can also be provided accordingly even if redundant sensor data which point to an unusual vibration at the gas turbine is present which is processed by redundant preprocessing units and evaluated by redundant processing units.

The claims submitted with the application are proposed formulations without prejudice for obtaining further patent protection. The applicant reserves the right to claim further combinations of features previously only disclosed in the description and/or drawings.

The exemplary embodiment or each exemplary embodiment is not to be understood as restricting the invention. Instead numerous changes and modification are possible within the framework of the present disclosure, especially such variants, elements and combinations, which for example can be derived by the person skilled in the art, by a combination or modification of individual features or elements or method steps described in the specific descriptive part as well as in the claims and/or the drawings in respect of the achievement of the object and lead through combinable features to new subject matter or to new method steps or sequences of method steps, even if they relate to manufacturing, testing and working methods.

References used in subclaims which refer back to claims indicate the further development of the subject matter of the main claim by the features of the respective subclaim; they are not to be understood as dispensing with the objective of an autonomous protection of the subject matter for the feature combinations of the referenced subclaims. Furthermore in respect of an interpretation of the claims for a more detailed specification of a feature in a subordinate claim, it is to be assumed that this type of restriction is not present in the preceding claims in each case.

Since the objects of the subclaims in respect of the prior art on the priority day can form separate and independent inventions, the applicant reserves the right to make them the object of independent claims or division declarations. They can furthermore also comprise self-contained inventions which have an embodiment independent of the previous subclaims.

### BRIEF DESCRIPTION OF THE DRAWING

An exemplary embodiment of the invention is explained in more detail below based on the drawing.

In this drawing the single FIGURE shows a schematic simplified block diagram of a monitoring system in accordance with the invention.

### DETAILED DESCRIPTION OF INVENTION

The FIGURE shows a schematic simplified block diagram of a monitoring system 10 as claimed in the invention. In the embodiment shown the monitoring system 10 comprises a first and second processing unit 12, 14, with the second processing unit 14 being provided as a redundant processing unit for the first processing unit 12. Redundancy is thus provided at the processing unit level. Each processing unit 12, 14 is able to communicate, e.g. via a bus, especially a so-called field bus, e.g. PROFIBUS, with one or more preprocessing units 16, 18, 20. From a plurality of theoretically possible preprocessing units 16, 18, 20, only a first, a second and a third preprocessing unit 16, 18, 20 are shown in the FIGURE. Each preprocessing unit 16, 18, 20 in this case is connected in a redundant manner both to the first processing unit 12 as also to its redundant second processing unit 14. One or more sensors 22 can be connected to each preprocessing unit 16, 18, 20. Each sensor 22 is intended for detection of signals from an external technical process not shown, when the monitoring system is used for vibration monitoring e.g. for recording vibration data of a technical process, such as a gas turbine for example. In the diagram depicted in the FIGURE only one sensor 22 is shown by way of example. This is redundantly connected to the first preprocessing unit 16 and the second preprocessing unit 18. This means that the second preprocessing units 18 assumes a function of a redundant preprocessing unit in relation to the first preprocessing unit 16 in relation to processing sensor data received from sensor 22. A further sensor not shown in the FIGURE can be connected in a corresponding manner e.g. redundantly to the first preprocessing unit 16 and the third preprocessing unit 20, with the third preprocessing unit 20 then assuming the function as redundant preprocessing unit for first preprocessing unit 16.

Overall the invention produces a monitoring system comprising one or more preprocessing units and one or more processing units (central units). This enables the availability of the system to be varied over a wide area without the use of specific hardware. The monitoring system, when fully configured, i.e. with sufficient redundancy at each level, that is at the level of the sensors 22, the level of the preprocessing units 16 to 20 and the level of the processing units 12, 14, is one-fault tolerant, in the sense that a single fault in the monitoring system does not result in any loss of information. This even still applies if a single fault occurs in a preprocessing unit 16 to 20 and a processing unit 12, 14. The method for operation of the monitoring system can be expanded by suitable voting in such a way that the reaction to the loss of information is such that the overall function of the system is safeguarded. Thus the reaction to the failure of a sensor 22, which is not configured redundantly, is such that a voting logic underlying the voting is automatically switched from 2v2 (two of two) to 1v1 (one of one). Reference is made in this respect to a procedural redundancy.

Overall the present invention can thus be briefly summarized as follows: A monitoring system is specified, especially a device for monitoring vibrations of turbines, with availability able to be finely adjusted from on the one side “purely single channel” to on the other side “one-fault-tolerant” and “restricted two-fault-tolerant” without the need for further specific hardware components.

1.-11. (canceled)

12. A monitoring system, comprising:
a preprocessing unit;
a plurality of sensors, wherein at least one is redundant, wherein a plurality of sensors are redundantly connectable to the preprocessing unit; and
a processing unit, wherein the preprocessing unit is redundantly connectable to the processing unit.

13. The monitoring system as claimed in claim 12, wherein the sensors have contacts for a redundant connection to two preprocessing units.

14. The monitoring system as claimed in claim 2, further comprising a redundant preprocessing unit, with at least one sensor connected simultaneously to the preprocessing unit and to the redundant preprocessing unit.

15. The monitoring system as claimed in claim 12, wherein each preprocessing unit has interfaces for redundant connection to two processing units.

16. The monitoring system as claimed in claim 15, further comprising a redundant processing unit, with at least one preprocessing unit being connected simultaneously to the processing unit and the redundant processing unit.

17. The monitoring system as claimed in claim 12, wherein the preprocessing unit is a field device to which a plurality of sensors as well as other process periphery is connected.

18. The monitoring system as claimed in claim 17, wherein the processing unit is a central station of a control system.

19. The monitoring system as claimed in claim 12, wherein the processing unit is connected to a PROFIBUS.

20. The monitoring system as claimed in claim 12, wherein at least one sensor is a vibration sensor.

21. The monitoring system as claimed in claim 12, wherein at least one sensor is a piezoelectric vibration sensors.

22. A vibration monitoring system, comprising:
a plurality of sensors, wherein at least one sensor is redundant, wherein a plurality of sensors are redundantly connected to at least one preprocessing unit of a plurality of preprocessing units; and
a plurality of processing units, wherein at least one of the plurality of preprocessing units is redundantly connected to at least on processing unit.

23. The vibration monitoring system as claimed in claim 22, wherein at least one sensor is a piezoelectric vibration sensor.

24. A method for operation of a monitoring system, comprising:
providing a monitoring system having:
a plurality of sensors, wherein at least one sensor is a redundant sensor, wherein a plurality of sensors are redundantly connectable to at least one preprocessing unit; and
at least one processing unit, wherein the preprocessing unit is redundantly connectable to the processing unit;
transmitting sensor data from the sensor or from each sensor to the or to each respective connected preprocessing unit; and
transmitting terminal data from the or from each preprocessing unit to the or to each respective connected processing unit.

25. The method as claimed in claim 24, wherein each preprocessing unit carries out voting on receipt of redundant sensor data.

26. The method as claimed in claim 24, wherein with each processing unit carries out voting on receipt of redundant terminal data.

27. The method as claimed in claim 25, wherein with each processing unit carries out voting on receipt of redundant terminal data.

28. The method as claimed in claim 24, wherein in a monitoring system with one processing unit and one redundant processing unit in conjunction with the sensor data, an action only being carried out by the processing unit or the redundant processing unit, if processing unit and redundant processing unit have the same terminal data available or after voting in conjunction with the terminal data have largely the same data available.

29. The method as claimed in claim 25, wherein in a monitoring system with one processing unit and one redundant processing unit in conjunction with the sensor data, an action only being carried out by the processing unit or the redundant processing unit, if processing unit and redundant processing unit have the same terminal data available or after voting in conjunction with the terminal data have largely the same data available.

30. The method as claimed in claim 26, wherein in a monitoring system with one processing unit and one redundant processing unit in conjunction with the sensor data, an action only being carried out by the processing unit or the redundant processing unit, if processing unit and redundant processing unit have the same terminal data available or after voting in conjunction with the terminal data have largely the same data available.

31. The method as claimed in claim 27, wherein in a monitoring system with one processing unit and one redundant processing unit in conjunction with the sensor data, an action only being carried out by the processing unit or the redundant processing unit, if processing unit and redundant processing unit have the same terminal data available or after voting in conjunction with the terminal data have largely the same data available.
